(19) United States
(12) Patent Application Publication
(10) Pub. No.: US 2009/0109616 A1
(43) Pub. Date: Apr. 30, 2009

(54) PORTABLE ELECTRONIC DEVICE BENT TO WIDTH DIRECTION, AND SLIDE MODULE AND PARTS THEREOF FOR THE DEVICE

(75) Inventor: Han Sang LEE, Seoul (KR)

Correspondence Address: ROBERTS MLOTKOWSKI SAFRAN & COLE, P.C.;Intellectual Property Department, P.O. Box 10064, MCLEAN, VA, 22102-8064, US

(73) Assignees: Han Sang LEE, Seoul (KR); P & TEL INC., Seoul (KR)

(21) Appl. No.: 12/254,980

(22) Filed: Oct. 21, 2008

(30) Foreign Application Priority Data
Oct. 26, 2007 (KR) 10-2007-0108511

(51) Int. Cl. G06F 1/16

(52) U.S. Cl. 361/679.56

(57) ABSTRACT

Disclosed is a portable electronic device bent widthwise. The portable electronic device includes: a first body bent widthwise; a second body mounted on the first body to be capable of being opened and closed, the second body being bent in the same direction as the first body; and a support member interposed between the first and second bodies so as to support the second body on the first body in such a manner that the second body can be opened and closed. The portable electronic device makes it possible to diversify the design of such a portable electronic device. In addition, the portable electronic device is convenient to grip. Furthermore, if the portable electronic device is configured in a slide-type, slippage of the thumb can be minimized when opening or closing the second body of the electronic device.

### BACKGROUND OF THE INVENTION

1. Field of the invention

The present invention relates to a portable electronic device, and a slide module and a part thereof for the device. More particularly, the present invention relates to a portable electronic device, such as a mobile phone or a PDA (Personal Digital Assistant), and a slide module and a part thereof for the device, wherein the portable electronic device includes a first body, in which main components, such as a main board, are mounted, a second body joined to the first body to be capable of being opened and closed, and support means installed between the first and second bodies so as to support the second body to be capable of being opened and closed.

2. Description of the Prior Art

In general, a “portable electronic device” means a device allowing a user to perform communication, to play games, to study, to listen to music, to watch TV, and so on while carrying it.

Such a portable electronic device includes a portable wireless phone, a PDA, an electronic calculator, an electronic scheduler, an MP3 player, a notebook computer, a portable game machine, or the like, and may be referred to as a portable terminal.

A conventional electronic device has a linear shape. Consequently, a first body, a second body, support means, etc. of such a conventional electronic device also have a linear shape.

### SUMMARY OF THE INVENTION

The applicant has discovered that the conventional linear shape electronic device has problems as follows.

Since all the parts including the first body are formed in a linear shape, it is difficult to diversify the design of such an electronic device. In addition, since such an electronic device is not conformably gripped by the palm of a user's hand, it provides a poor grip feeling.

In particular, in a slide-type portable electronic device, a portion on the electronic device, with which the user's thumb is in contact, should be moved along a linear trace, which does not conform to the curved trace of movement of the thumb. As a result, slippage is caused between the surface of the portable electronic device and the contact area on the thumb. Consequently, the slidably opening/closing operation of the electronic device is not smoothly performed, and is inconvenient. Furthermore, if such an opening/closing operation is repeated many times, pain may be caused on the contact area of the thumb.

Accordingly, the present invention has been made to solve the above-mentioned problems occurring in the prior art, and the present invention is intended to provide a portable electronic device which can be diversified in design.

In addition, the present invention is intended to provide a portable electronic device with a good grip feeling.

In addition, the present invention is intended to provide a portable electronic device which allows the thumb of the user's hand to be conveniently moved when slidably opening and closed the electronic device.

In addition, the present invention is intended to provide a slide module suitable for the inventive portable electronic device.

Lastly, the present invention is intended to provide a guide member suitable for the inventive portable electronic device and the inventive slide module.

According to a first aspect of the present invention, there is provided a portable electronic device bent widthwise, including: a first body bent widthwise; a second body mounted on the first body to be capable of being opened and closed, the second body being bent in the same direction as the first body; and support means interposed between the first and second bodies so as to support the second body on the first body in such a manner that the second body can be opened and closed.

The support means may include a slide guide part provided on the first body and bent in the same direction as the first body, and a slidably guided part formed on the second body along a course bent in the same direction as the first body, the slidably guided part being engaged with and guided by the slide guide part.

If desired, the support means may include a slide guide part provided on the first body and bent in the same direction as the first body, and a slidably guided part formed on the second body along a course bent in the same direction as the first body, the slidably guided part being engaged with and guided by the slide guide part. In such a case, a spring may be preferably provided between the first and second bodies so as to apply elastic force in the direction of opening or closing the second body depending on the position of the second body.

It is preferable if the slide guide part is formed by joining a separate guide member having a slide guide part to the first body.

It is also preferable if the slidably guided part is formed by joining a separate slide member having a slidably guided part to the second body.

If desired, the support means may be a hinge module provided at the top end of the first body so as to allow the second body to be opened and closed as a folder type.

According to another aspect of the present invention, there is provided a slide module installed between first and second bodies of a portable electronic device so as to allow the second body to be slidably opened and closed, the slide module including: a guide member having a slide guide part bent widthwise, the guide member being adapted to be joined to the first body; a slide member having a slidably guided part arranged along a course bent in the same direction as the guide part, the slidably guided part being engaged with and guided by the guide part, the slide member being adapted to be joined to the second body; and a spring interposed between the guide member and the slide member so as to apply elastic force in the direction of opening or closing the slide member depending on the position of the slide member.

According to another aspect of the present invention, there is provided a guide member of a slide module, the slide module being installed between first and second bodies of a portable electronic device so as to allow the second body to be slidably opened and closed, the guide member being bent widthwise and including a slide guide part bent widthwise.

Since the inventive portable electronic device is bent widthwise, it allows the design of such a portable electronic device to be diversified, and is convenient to grip.

In addition, when the inventive portable electronic device is a slide-type, the slippage of the thumb of the user's hand on the surface of the second body of the electronic device can be reduced, whereby the electronic device can be conveniently operated by hand.

Furthermore, when the inventive portable electronic device is accidentally dropped on a floor, the center of weight of the electronic device is biased to the convexly bent side of the electronic device. As a result, the possibility of the convexly bent area of the electronic device coming into contact with the floor first is high. Consequently, if the resistance to shock is enhanced at the convexly bent area, the electronic device will not be damaged, even if it is frequently dropped.

Moreover, if a side of the left convex area of the electronic device, except the left central areas of the top and bottom sides of the electronic devices, comes into contact with the floor first when the portable electronic device is dropped, the electronic device will roll, so that the shock can be alleviated.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing a portable electronic device according to an embodiment of the present invention;

FIG. 2 is a perspective view showing the portable electronic device of FIG. 1 in a state in which the second body of the electronic device is slid and opened;

FIG. 3 is an exploded perspective view of the portable electronic device of FIG. 1;

FIG. 4 is an exploded perspective view corresponding to the reversed state of FIG. 3;

FIGS. 5 and 6 are views for describing processes of opening/closing the portable electronic device of FIG. 1;

FIGS. 7 and 8 are views for describing the traces of the tip of the thumb of the user's hand when opening/closing the portable electronic device of FIG. 1; and

FIG. 9 is a perspective view showing a portable electronic device according to another embodiment of the present invention.

### DETAILED DESCRIPTION OF THE EXEMPLARY EMBODIMENTS

Hereinafter, exemplary embodiments of the present invention will be described with reference to the accompanying drawings in order for a person skilled in the art to be capable of easily embodying the present invention.

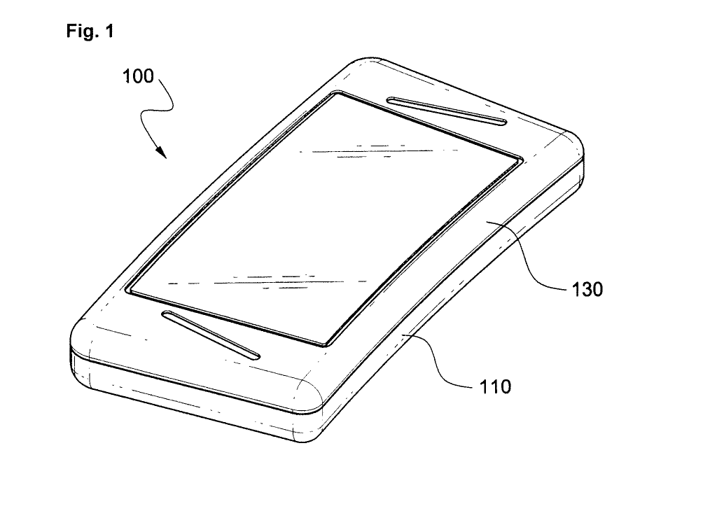

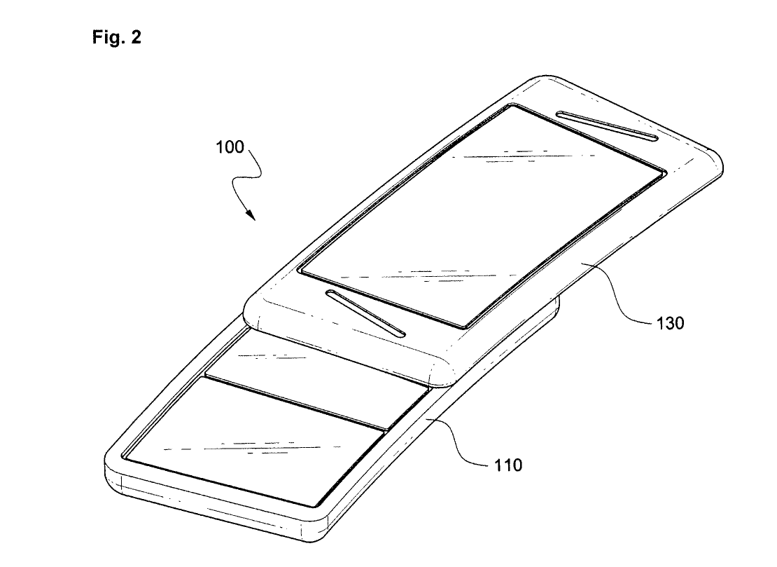

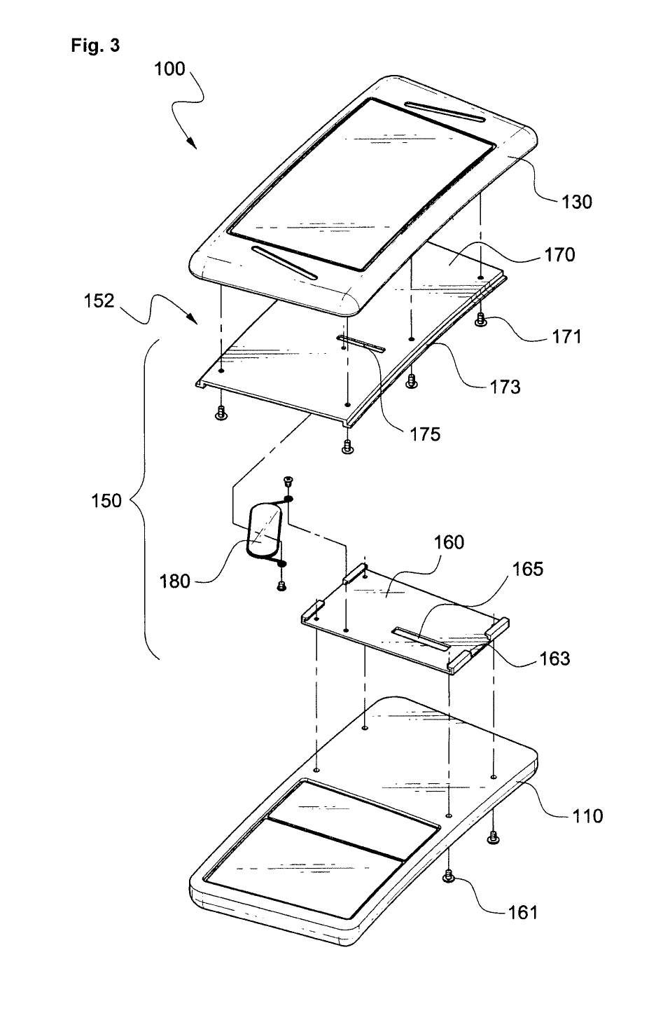

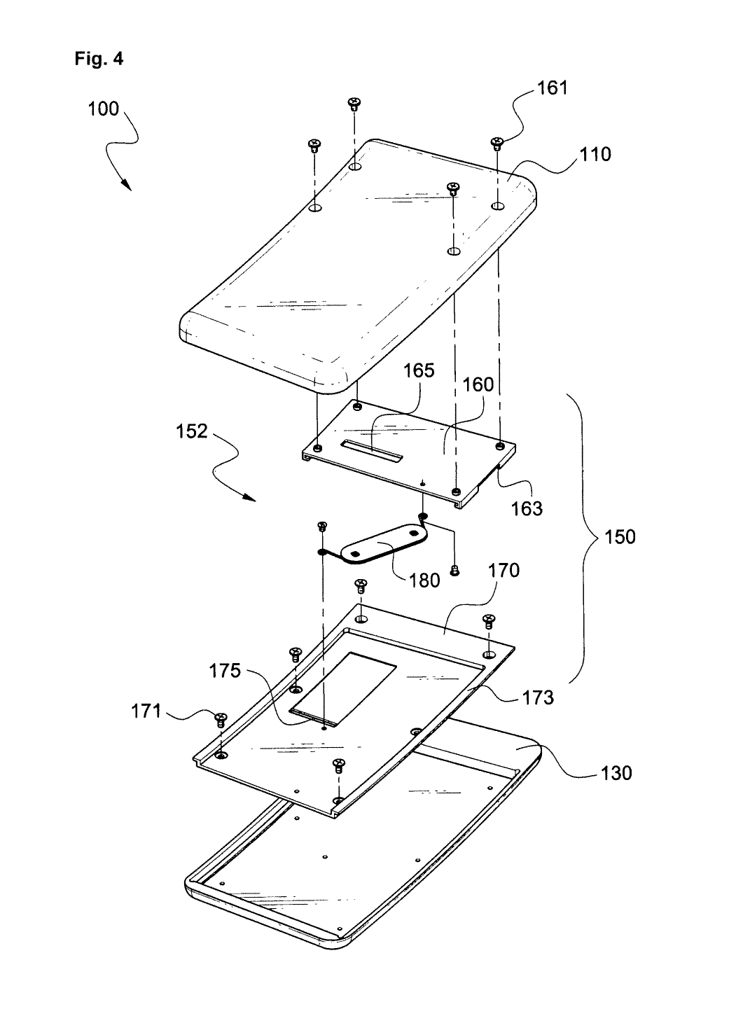

FIG. 1 is a perspective view showing a portable electronic device according to an embodiment of the present invention, and FIG. 2 is a perspective view showing the portable electronic device of FIG. 1 in a state in which the second body of the electronic device is slid and opened. In addition, FIG. 3 is an exploded perspective view of the portable electronic device of FIG. 1, and FIG. 4 is an exploded perspective view corresponding to the reversed state of FIG. 3.

As shown in the drawings, the inventive portable electronic device 100 includes a first body 110 which is bent widthwise. The first body 110 is a component, in which a main board and related parts are mounted, and various input keys are mainly mounted on the surface of the first body 110. The first body 110 is bent to the right side when approaching the top thereof.

The inventive portable electronic device 100 includes a second body 130, which is bent widthwise. The second body 130 is equipped with a display, and is configured to be opened and closed through sliding movement on the first body 110. The second body 130 is also bent to the right side when approaching the top thereof like the first body 110.

Although the first and second bodies 110 and 130 are bent to the right side thereof in the present embodiment, it is also possible to configure the first and second bodies in such a manner that they are bent to the left side thereof when approaching the top thereof.

Support means 150 is provided between the first and second bodies 110 and 130, so that the support means 150 supports the second body 130 to be capable of being opened and closed on the first body 110.

The support means 150 shown in FIGS. 1 to 4 is a slide module 152, which includes a guide member 160 fixed at the first body 110 by screw members 161. The guide member 160 is formed with slide guide parts 163 along the opposite longitudinal edges of the guide member 160. Each of the slide guide parts 163 takes a form of lateral groove with an opened inner side, and is bent to the same direction and in the same curvature as the first body 110. The slide guide parts 163 serve to guide the second body 130 to be slidably opened and closed on the first body 110. The guide member 160 is formed with a through-hole 165, through which a flexible connector extends, wherein the first and second bodies 110 and 130 exchanges a control signal, a data signal, or the like through the flexible connector.

If desired, the slide guide parts 163 may be integrally formed on the first body 110. If so, the guide member 160 is not required.

The support means 150 includes a slide member 170 with slidably guided parts 173. The slide member 170 is fixed to the bottom side of the second body 130, and the slidably guided parts 173 are formed along the opposite longitudinal edges of the bottom side of the second body 130. Each of the slidably guided parts 173 is also bent to the same direction and in the same curvature as the first body 110. The slide member 170 is also formed with a through-hole 175, through which the flexible connector extends.

If desired, the slidably guided parts 173 may be integrally formed on the second body 130. If so, the slide member 170 is not required.

Alternatively, it is possible to form each of the slidably guided parts 173 with a shaft with a circular cross-section, and to form each of the slide guide parts 163 with a hole with a circular cross-section, or a groove with a semicircular cross-section.

A torsion spring 180 is provided between the guide member 160 and the slide member 170. The torsion spring 180 is interposed between the first and second bodies 110 and 130 so as to provide elastic force to the second body 130 biased to the opening direction or closing direction of the second body 130, depending on the position of the second body 130. It can be appreciated that another type of spring may be employed instead of the torsion spring 180. One end of the torsion spring 180 is connected to the first body 110, and the other end is connected to the slide member 170. If the slidably guided parts 173 are directly formed on the second body 130, the other end of the torsion spring 180 may be directly connected to the second body 130.

Here, the above-mentioned slide module 152 may be manufactured and sold as a separate component of the portable electronic device 100, wherein the slide module 152 includes: the guide member 160 with the slide guide parts 163 which are bent widthwise, the guide member 160 being adapted to be joined to the first body 110; the slide member 170 having the slidably guided parts 173 which are arranged along a course bent to the same direction as the slide guide parts 163, and are engaged with and guided by the slide guide parts 163, the slide member 170 being adapted to be joined to the second body 130; and the torsion spring 180 interposed between the guide member 160 and the slide member 170 so as to provide elastic force to the second body 130 biased to the opening direction or closing direction of the second body 130, depending on the position of the second body 130.

If desired, only the guide member 160 can be separately manufactured and sold, that it can be employed in manufacturing the inventive portable electronic device 100.

The portable electronic device 100 shown in FIGS. 1 to 4 is bent widthwise, thereby allowing the design of such a portable electronic device to be diversified. Since the opposite sides of the portable electronic device 102 are formed in a curved shape to be conformally gripped by the palm of a user's hand, the portable electronic device 102 is convenient to grip.

In addition, if the portable electronic device 100 is accidentally dropped on a floor, and a side of the left convex area of the electronic device 100, except the left central areas of the top and bottom sides of the electronic devices, comes into contact with the floor first, the electronic device 100 will roll, so that shock can be alleviated.

If the inventive portable electronic device is formed in a slide-type, it is possible to reduce the slippage of the thumb of the user's hand on the surface of the second body at the time of opening or closing the second body, whereby the second body can be conveniently moved.

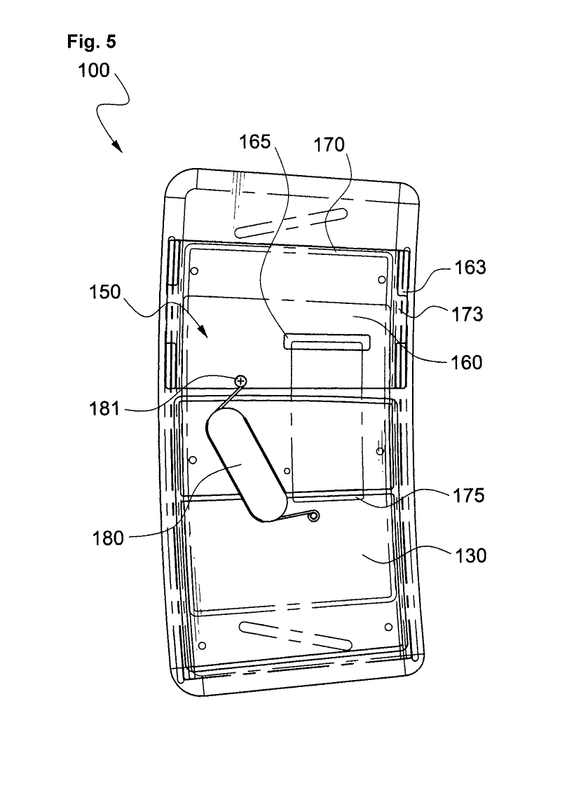

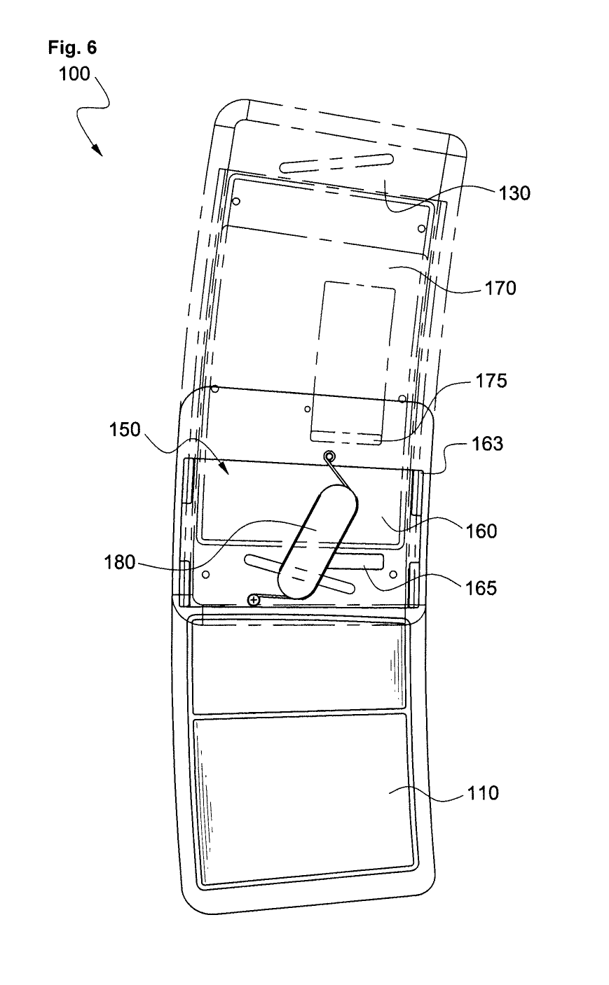

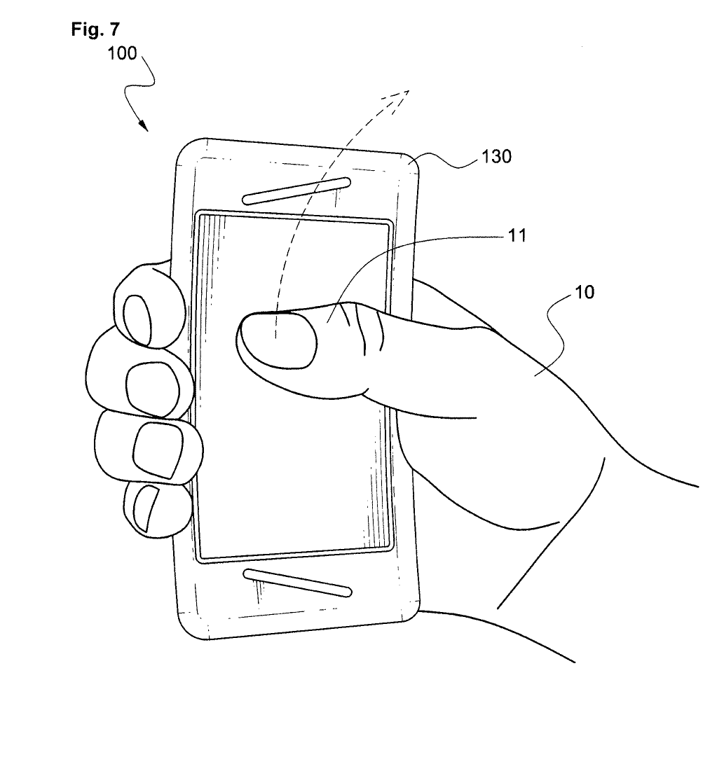

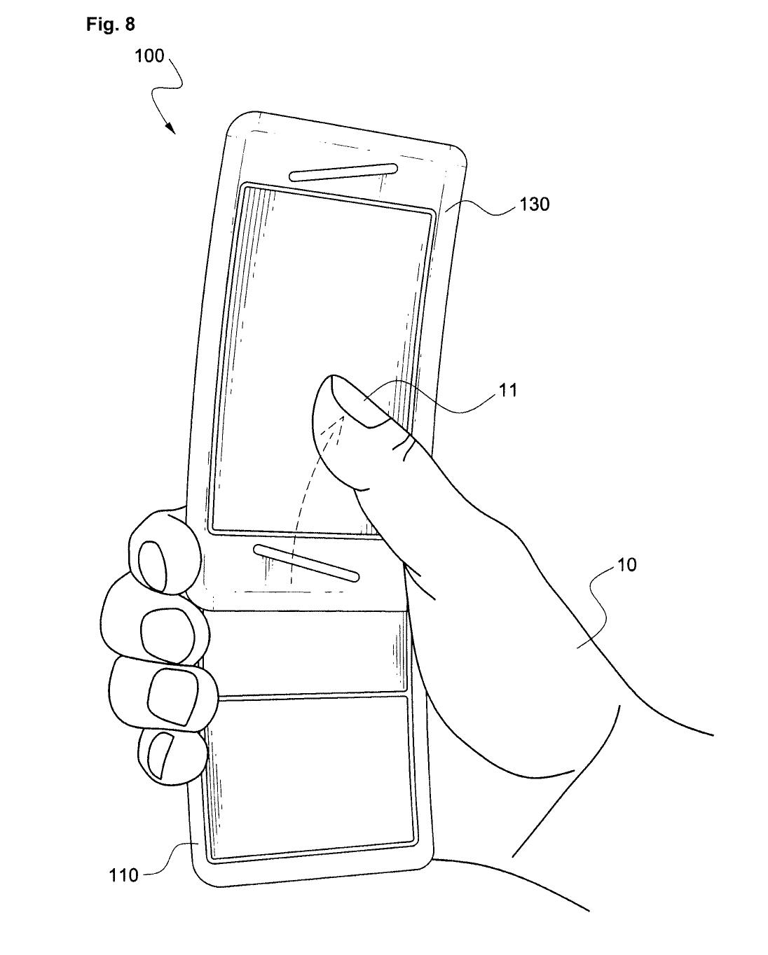

FIGS. 5 and 6 are views for describing processes of opening/closing the portable electronic device of FIG. 1, and FIGS. 7 and 8 are views for describing the traces of the tip of the thumb of the user's hand when opening/closing the portable electronic device of FIG. 1.

As shown in FIG. 5, if the tip of the thumb 11 is pushed upward in the state in which the portable electronic device 100 is gripped as shown in FIG. 7, the second body 130 is slightly turned right while being moved upward along the slide guide parts 163 of the guide member 160 provided in the first body. Consequently, the second body 130 is slightly turned clockwise while being slid. At this time, the tip of the thumb 11 is moved along a trace slightly turning clockwise. In this movement, the tip of the thumb 11 performs a substantially circular movement about the lower end of the thumb 11. During this process, the turning radius of the second body 130 is larger than that of the tip of the thumb 11. Therefore, a small slippage is caused at the area where the thumb 11 is in contact with the second body 130. However, since the second body is turned right while being moved upward, the slippage is smaller than the slippage which may be caused on a conventional linear slide-type electronic device, the turning radius of which is unlimited. If the turning radius of the second body 130, i.e. the radius of curvature of the slide guide parts 163, is reduced and approaches the radius of curvature of the tip of the thumb 11, a smaller slippage will be caused at the tip of the thumb 11. FIG. 6 shows the state in which the second body 130 has been fully opened through the above-mentioned process.

The torsion spring 180 biases the second body 130 downward when the second body 130 is in the closed state as shown in FIG. 5, and biases the second body 130 upward when the second body 130 is in the opened state as shown in FIG. 7. The torsion spring 180 turns counterclockwise about a top abutment point 181 fixed to the guide member 160 as shown in FIG. 5, thereby biasing the second body 130 upward when the second body 130 is in the opened state.

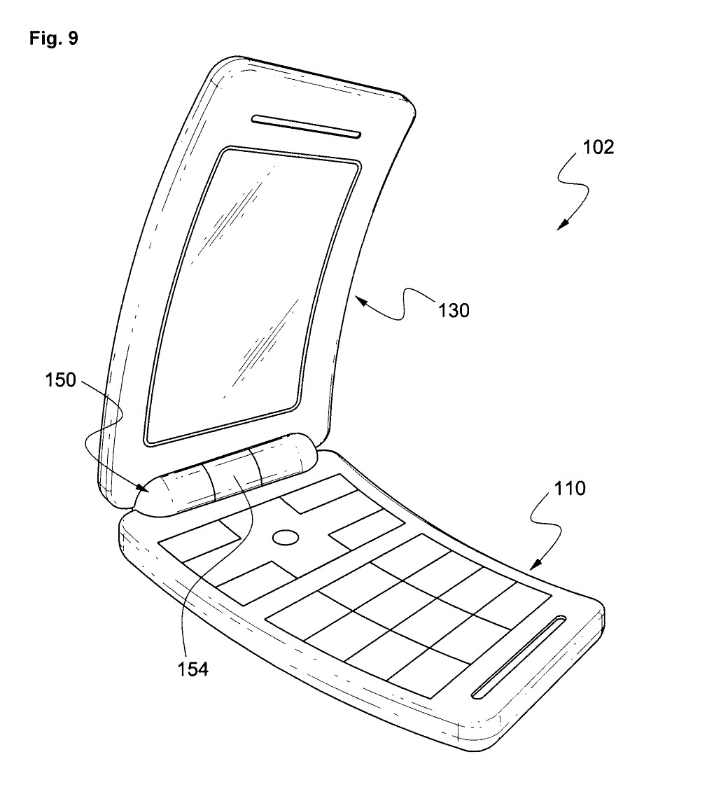

FIG. 9 is a perspective view showing a portable electronic device according to another embodiment of the present invention.

As shown in FIG. 9, the inventive portable electronic device 102 can be configured in such a manner that a hinge module 154, rather than the slide module 152, is employed as the support means 152 interconnecting the first and second bodies 110 and 130, thereby allowing the second body to be opened and closed as a folder-type. In that event, the hinge module 154 may be provided at the top end of the first body 110, and a corresponding end of the second body 130 may be connected to the hinge module 154. A conventional hinge module may be employed as the hinge module 154.

Since the portable electronic device 102 of FIG. 1 also has opposite sides formed in a curved shape which is conformably gripped by the palm of a user's hand, it is convenient to grip, and allows the design to be diversified.

In addition, if the portable electronic device 102 is accidentally dropped on a floor, and a side of the left convex area of the electronic device 102, except left the central areas of the top and bottom sides of the electronic devices, comes into contact with the floor first, the electronic device 102 will roll, so that shock can be alleviated.

As described above, the present invention can be used when manufacturing a portable electronic device, and components thereof.

Although a exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A portable electronic device bent widthwise, comprising:
a first body bent widthwise;
a second body mounted on the first body to be capable of being opened and closed, the second body being bent in the same direction as the first body; and
a support means interposed between the first and second bodies so as to support the second body on the first body in such a manner that the second body can be opened and closed.

2. The portable electronic device as claimed in claim 1, wherein the support means comprises a slide guide part provided on the first body and bent in the same direction as the first body, and a slidably guided part formed on the second body along a course bent in the same direction as the first body, the slidably guided part being engaged with and guided by the slide guide part.

3. The portable electronic device as claimed in claim 1, wherein the support means comprises a slide guide part provided on the first body and bent in the same direction as the first body, and a slidably guided part formed on the second body along a course bent in the same direction as the first body, the slidably guided part being engaged with and guided by the slide guide part, and wherein a spring is provided between the first and second bodies, which provides elastic force in the direction of opening or closing the second body depending on the position of the second body.

4. The portable electronic device as claimed in claim 1, wherein the slide guide part is formed by joining a separate guide member having a slide guide part to the first body.

5. The portable electronic device as claimed in claim 2, wherein the slide guide part is formed by joining a separate guide member having a slide guide part to the first body.

6. The portable electronic device as claimed in claim 3, wherein the slide guide part is formed by joining a separate guide member having a slide guide part to the first body.

7. The portable electronic device as claimed in claim 1, wherein the slidably guided part is formed by joining a separate slide member having a slidably guided part to the second body.

8. The portable electronic device as claimed in claim 2, wherein the slidably guided part is formed by joining a separate slide member having a slidably guided part to the second body.

9. The portable electronic device as claimed in claim 3, wherein the slidably guided part is formed by joining a separate slide member having a slidably guided part to the second body.

10. The portable electronic device as claimed in claim 1, wherein the support means is a hinge module provided at the top end of the first body so as to allow the second body to be opened and closed as a folder type.

11. A slide module installed between first and second bodies of a portable electronic device so as to allow the second body to be slidably opened and closed, the slide module comprising:
a guide member having a slide guide part bent widthwise, the guide member being adapted to be joined to the first body;
a slide member having a slidably guided part arranged along a course bent in the same direction as the guide part, the slidably guided part being engaged with and guided by the guide part, the slide member being adapted to be joined to the second body; and
a spring interposed between the guide member and the slide member so as to apply elastic force in the direction of opening or closing the slide member depending on the position of the slide member.

12. A guide member of a slide module, the slide module being installed between first and second bodies of a portable electronic device so as to allow the second body to be slidably opened and closed, the guide member being bent widthwise and comprising:
a slide guide part bent widthwise.
